(19) United States
(12) Patent Application Publication
(10) Pub. No.: US 2018/0034762 A1
(43) Pub. Date: Feb. 1, 2018

(54) METHODS FOR SEMI-DISTRIBUTED DATA DELIVERY

(71) Applicant: Andrei Odeski, Vancouver (CA)

(72) Inventor: Andrei Odeski, Vancouver (CA)

(21) Appl. No.: 15/224,623

(22) Filed: Jul. 31, 2016

(51) Int. Cl. H04L 12/58

(52) U.S. Cl. CPC H04L 51/22; H04L 67/42

(57) ABSTRACT

The system could be used but not limited to scenario of a secure email application where each message could be an email sent from one client to another. In this particular case each client is a mobile device and receiving end is another mobile device, and encrypted data is distributed and stored amongst the other connected mobile devices or any other devices. Availability and distribution of the data is controlled via the citadel server.

Another potential use case could be a file sharing application where someone is sending a file for storage and a client is a desktop computer and storage clients could be dumb storage clients that are just software programs connected to citadel management server, designed for storing encrypted chunks.

Another potential use case could be video and Voice over IP applications where sending and receiving data is not limited to files but also can include voice and video.

The design is not limited and can consist of any combination of mobile and other devices acting either as clients or dumb storage instances for any applications that interchange data.

### CROSS REFERENCES TO RELATED APPLICATIONS

Not applicable

### STATEMENT REGARDING FEDERALLY SPONSORED RESEARCH OR DEVELOPMENT

Not applicable

### MICROFICHE APPENDIX

Not applicable

### BACKGROUND OF INVENTION

### 1. Field of Invention

The invention relates to the field of securing computer data communication its storage and distribution. More specifically relates to a semi-distributed model of information storage, whereby the clients are used as storage devices and server decides how to use the pool of connected clients to redistribute securely encrypted pool of data that comprises the storage.

### 2. Description of Related Art

In the recent years peer to peer communication has become a very popular model of storing and communicating the data. Example of this includes systems as well as many peer to peer voice over ip communication software such as Napster, Morpheus, Gnutella, Freenet, BitTorrent and Skype. There are many use cases of peer to peer communication such as: file sharing, instant messaging, voice communication, collaboration, backup systems, sensor nets, distributed computing, defense systems.

The peer to peer architecture has no central server and the information is distributed amongst all the peers on the network. A peer may need to contact with more then one peer to find out where the information piece is.

However as good as peer to peer systems are they face a few challenges. Firstly, finding peers on the network may be problematic, as there are no central servers to keep track of connected clients. Storing and locating information on the network maybe difficult as there are no quality service guarantee to the data distribution. Maintaining stable and fully accessible network is also a challenge as any service can go down without a central server to maintain minimal number of available data pieces. Also supporting secure communication has been a problem as there is no control over where each packet goes over which networks.

### BRIEF SUMMARY OF PRESENT INVENTION

The present invention attempts to create a highly scalable, stable and secure information exchange process using a semi distributed model by having a pool of connected clients to store the data and a centralized server or set of servers called citadel to manage data flow and maintain acceptable level of redundancy as well as data encryption and distribution.

Finding peers on a network becomes an easy task of connecting to the right citadel. Storing and locating information in a network becomes a job of a citadel therefore easing the job of the clients without having to worry about where to grab the piece. Citadel also maintains the distribution and correct level of duplication of data to ensure a fully accessible network. Securing communication is done via public private and symmetric key distribution, with the core of the distribution still relying on the pool of distributed clients. Each client is also a store for someone else's data.

### BRIEF DESCRIPTION OF THE SEVERAL VIEW OF THE DRAWINGS

FIG. 1 is a view showing the data flow when we send data from one client to the other.

FIG. 2 is a view showing retrieval of the data by destination client.

FIG. 3 is a view showing rebalancing of the data in case a client is disconnected

REFERENCE NUMERALS IN THE DRAWINGS

| | | | |
|---|---|---|---|
| 8 | Message being sent | 10 | Client A |
| 12 | Citadel management server | 14 | Client B |
| 16 | Client B symmetric key | 18 | Client A public key |
| 20 | Client C | 22 | Client D |
| 24 | Client E | 26 | Client G |
| 28 | Client H | 30 | Client I |
| 32 | Client J | 34 | Client K |
| 36 | Client L | | |

### DETAILED DESCRIPTION OF THE INVENTION

Each client is a generic system for storage and retrieval of data. Any generic device can be used as client for storing information. It has to have a network capability and implement public private key generation, as well as a symmetric key and a set of API calls to be able to send and receive data.

Citadel 12 is a server system that manages connected clients their states as well as sending and retrieving data to and from the connected clients.

After generating of keys each client connects to a citadel server. Once client connects it is assumed as connected by citadel. Citadel 12 then is able to store and retrieve parts of data on any connected client.

A network of connected clients is able to form platform for data storage. The total data storage size is determined by the total size of connected clients.

### Sending Data

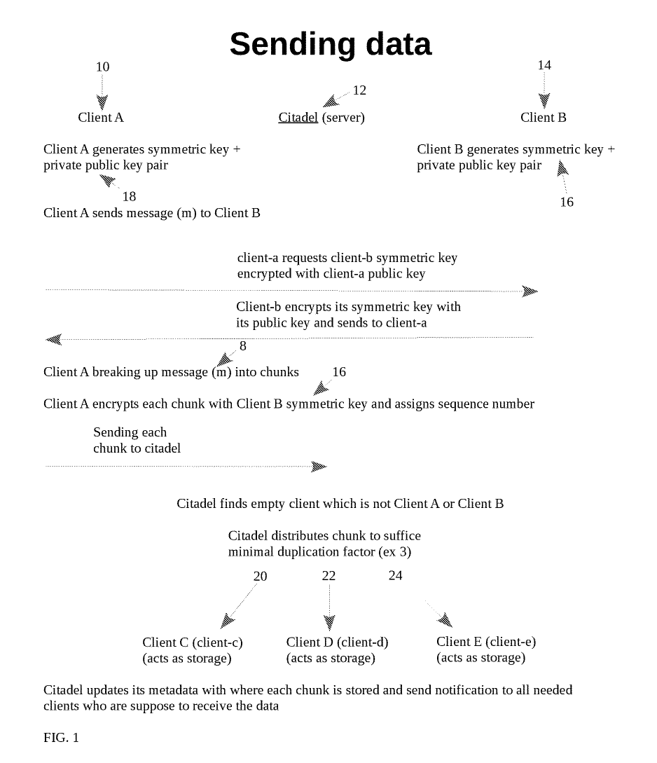

FIG. 1 shows a view of sending data from Client A to Client B. The data flow includes Client A 10, Client B 14, Citadel server 12, Client B symmetric key 16, Client A public key 18. The message 8 being sent from Client A to Client B. Client C 20, Client D 22, Client E 24 store the parts for chunked message 8 using encrypted format.

Client A 10 requests for encrypted symmetric key 16 of the Client B with its public key 18, which we are trying to communicate data to, through a Citadel server 12. Client A breaks down the message data 8 using optimal size of a single data chunk. Client A 10 then encrypts each chunk separately using the symmetric key 16 of Client B 14. Every part of a message 8 are sent to the Citadel 12. Citadel is our central data management service which determines where all the parts are going to be stored. After determining which client can accept encrypted chunk citadel forwards the part to store to that client. Any connected client can store parts with an exception of destination client and the originator. In our example that message part is duplicated to Client C 20, Client D 22, and Client E 24. This is an example of a single part distribution, a message is composed of many parts that will be saved and duplicated likewise. After each successful save destination clients confirms successful receipt and storage of the chunk. Only after the last chunk has been reported as saved on remote clients is the successful status reported to Client A 10 and Client B 14. Citadel server 12 is also configured with duplication factor which determines how many duplicates of each encrypted chunk to store. Same rules of storing are applied to duplicated parts, they can be stored on any client other then Client A 10 or Client B 14.

### Retrieving Data

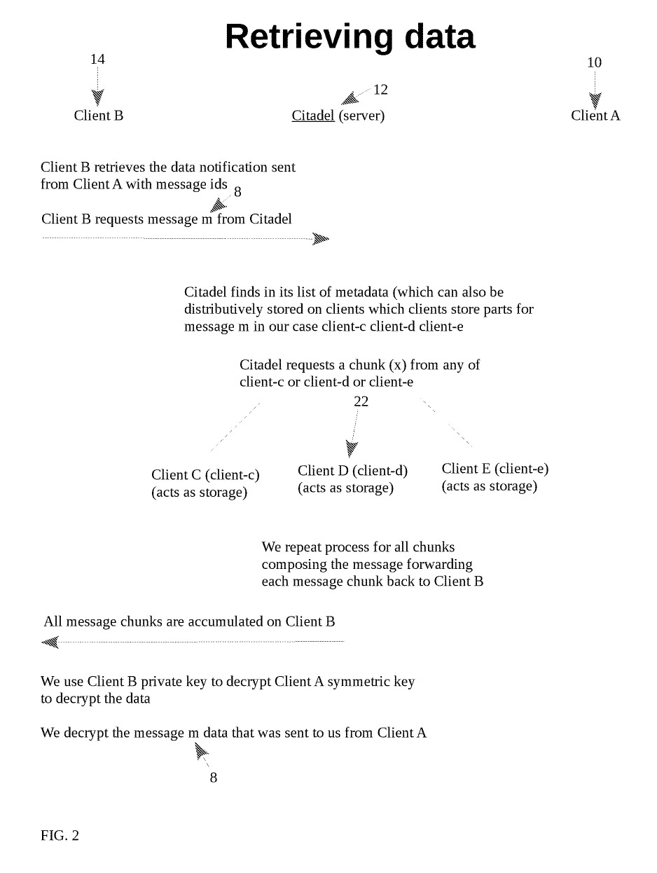

FIG. 2 shows retrieving data by the Client B 14, of the message that was sent from Client A 10. After receiving of notification from the Citadel about receiving of a message 8, Client B needs to actually download and decrypt the message. Its requesting to download message 8 from the Citadel 12 which can randomly pick any part as they are equivalent from where it has been duplicated on Client C 20, Client D 22 or client E 24. The remainder of the message chunks are sent back by the Citadel 12 to Client B 14 collecting all chunks from other clients in a similar fashion.

### Rebalancing of Data

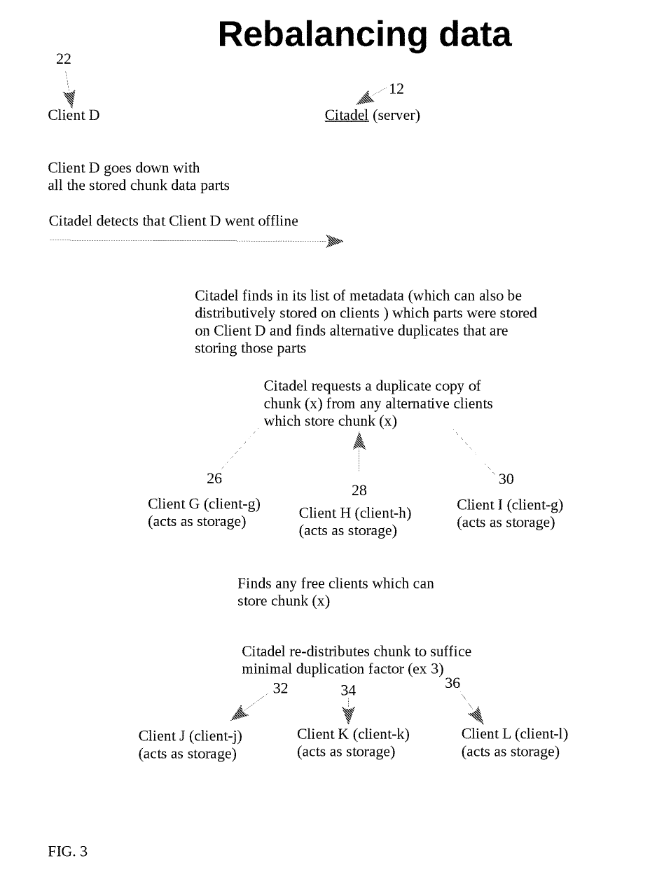

In a case of client going offline and citadel determines its state as disconnected, it starts to initiate a process called rebalancing which is designed to keep availability and data integrity which is described in FIG. 3. Client D 22 goes offline suddenly. Citadel server 12 detects that Client D 22 is offline requesting to rebalance existing parts stored on other clients. In our example the duplicate copy of the part is stored on Client G 26, Client H 28, Client I 30. We need to rebalance part that was originally stored on Client D 22 to another freely available client that is not sender Client A 10 or destination Client B 14. We randomly pick where to copy part from in this case Client H 28, and then duplicate a part to one or more clients to maintain that parts availability. In our example we duplicate that part to Client J 32, Client K 34, Client L 36.

Having described by invention, I claim:

1. A method of communicating encrypted chunked data from any network attached device to any other network attached device both of which can act as a client and storage devices through the means of a management mechanism.

2. A method of rebalancing data for communication method as recited in claim 1.

3. A method of a “single swipe” action on the client which deletes data by destroying the keys on the clients. Thus making all distributed data inaccessible.

4. A method of exporting encrypted client keys in a distributed storage system as in the form of a QR code for further import, on any other clients.

5. A method of remote deleting and updating of data on clients through citadel management system (combination of FIG. 1 and FIG. 2).

6. A method of importing data from the distributed clients by re-downloading the encrypted data chunks and importing QR code as recited in claim 4, and FIG. 1 and FIG. 2.
